(19) United States
(12) Patent Application Publication
(10) Pub. No.: US 2021/0206406 A1
(43) Pub. Date: Jul. 8, 2021

(54) WHEELSET RFID TAG UNIT

(71) Applicant: KAWASAKI JUKOGYO KABUSHIKI KAISHA, Kobe-shi, Hyogo (JP)

(72) Inventors: Yoshi SATO, Sanda-shi (JP); Takashi MIYAZAKI, Kobe-shi (JP); Kyoko YOSHIDA, Kobe-shi (JP)

(73) Assignee: KAWASAKI JUKOGYO KABUSHIKI KAISHA, Kobe-shi, Hyogo (JP)

(21) Appl. No.: 17/059,115

(22) PCT Filed: Apr. 26, 2019
(86) PCT No.: PCT/JP2019/017955

§ 371 Date: Nov. 25, 2020

Related U.S. Application Data
(60) Provisional application No. 62/676,471, filed on May 25, 2018.

(51) Int. Cl. B61L 25/04; B60B 17/00; G06K 19/077

(52) U.S. Cl. CPC B61L 25/048; G06K 19/07758; B60B 17/0024

(57) ABSTRACT

A RFID tag unit is attached to a wheelset of a railcar and includes a RFID tag and an attaching member on which the RFID tag is mounted and which is attached to the wheelset. At least a portion of the attaching member which portion faces the RFID tag is made of a non-metal material. The attaching member is interposed between the RFID tag and the wheelset.

### CROSS-REFERENCE TO RELATED APPLICATION

This application claims the benefit of U.S. Provisional Patent Application No. 62/676,471, filed May 25, 2018, which is incorporated by reference herein in its entirety.

### TECHNICAL FIELD

The present application relates to a RFID tag unit attached to a wheelset of a railcar.

### BACKGROUND

Conventionally, an axle includes a configuration in which a data carrier (IC tag) in which a management code for maintenance is written is embedded in a center hole formed at a center position of a center prepared hole of an end portion of the axle.

### SUMMARY

However, since the IC tag is directly attached to the axle made of metal, in order to secure communication reliability, the IC tag needs to be a meal-compatible tag that is expensive. Moreover, the IC tag is arranged at a deep portion of the center hole of the axle. Therefore, in order to read the management code, a reader needs to be brought into contact with the surface of the axle so as to be located close to the IC tag, and convenience at the time of maintenance is low. Moreover, when the IC tag is attached to a wheelset, the IC tag may fall off due to centrifugal force or traveling vibration during rotation of the wheelset.

An object of the present disclosure is to provide a configuration capable of eliminating factors which inhibit the spread of wheelset management using RFID tags.

### SOLUTION TO PROBLEM

A wheelset RFID tag unit according to one aspect of the present disclosure is a RFID tag unit configured to be attached to a wheelset of a railcar. The wheelset RFID tag unit includes: a RFID tag; and an attaching member on which the RFID tag is mounted and which is configured to be attached to the wheelset. At least a portion of the attaching member which portion faces the RFID tag is made of a non-metal material. The attaching member is interposed between the RFID tag and the wheelset.

According to the above configuration, the attaching member is interposed between the wheelset made of metal and the RFID tag, and the RFID tag faces the portion of the attaching member which portion is made of the non-metal material. Therefore, an inexpensive metal-incompatible RFID tag can be used instead of using an expensive meal-compatible RFID tag.

A wheelset RFID tag unit according to another aspect of the present disclosure is a RFID tag unit configured to be attached to a wheelset of a railcar. The wheelset RFID tag unit includes: a RFID tag; and an attaching member on which the RFID tag is mounted and which is configured to be attached to the wheelset. The attaching member includes a portion which supports the RFID tag from a radially outer side of the wheelset against centrifugal force.

According to the above configuration, the RFID tag is supported by the attaching member from a radially outer side. Therefore, the RFID tag can be prevented from being peeled off from the attaching member by centrifugal force during the rotation of the wheelset.

A wheelset RFID tag unit according to yet another aspect of the present disclosure is a RFID tag unit configured to be attached to a wheelset of a railcar. The wheelset RFID tag unit includes: a RFID tag; and a circular-arc attaching surface configured to be attached to a peripheral surface of the wheelset, the peripheral surface extending around an axis of the wheelset.

According to the above configuration, the attaching surface of the RFID tag unit is formed in a circular-arc shape. Therefore, the RFID tag unit can be easily and stably attached to the peripheral surface of the wheelset.

### BRIEF DESCRIPTION OF DRAWINGS

FIG. 1 is a sectional view showing that a wheelset RFID tag unit according to Embodiment 1 is attached to a wheelset.

FIG. 2A is a front view showing the wheelset RFID tag unit of FIG. 1. FIG. 2B is a side view showing the wheelset RFID tag unit of FIG. 1.

FIG. 3A is a perspective view showing that the wheelset RFID tag unit according to Embodiment 2 is attached to the wheelset. FIG. 3B is a sectional view showing that the wheelset RFID tag unit according to Embodiment 2 is attached to the wheelset.

FIG. 4 is a sectional view showing a modified example of the wheelset RFID tag unit according to Embodiment 2.

FIG. 5A is a sectional view showing that the wheelset RFID tag unit according to Embodiment 3 is attached to the wheelset. FIG. 5B is a front view showing that the wheelset RFID tag unit according to Embodiment 3 is attached to the wheelset.

FIG. 6A is a sectional view showing that the wheelset RFID tag unit according to Embodiment 4 is attached to the wheelset. FIG. 6B is a front view showing that the wheelset RFID tag unit according to Embodiment 4 is attached to the wheelset.

FIG. 7A is a sectional view showing that the wheelset RFID tag unit according to Embodiment 5 is attached to the wheelset. FIG. 7B is a sectional view showing a first modified example of the wheelset RFID tag unit according to Embodiment 5. FIG. 7C is a sectional view showing a second modified example of the wheelset RFID tag unit according to Embodiment 5.

FIG. 8 is a sectional view showing that the wheelset RFID tag unit according to Embodiment 6 is attached to the wheelset.

FIG. 9 is a plan view showing that the wheelset RFID tag unit according to Embodiment 7 is attached to the wheelset.

### DESCRIPTION OF EMBODIMENTS

Hereinafter, embodiments will be described with reference to the drawings.

### Embodiment 1

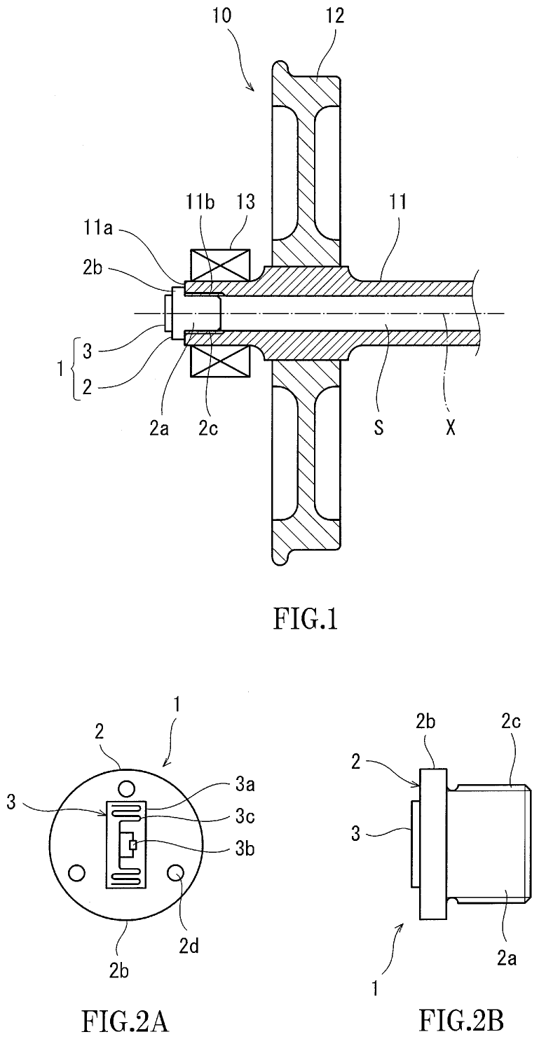

FIG. 1 is a sectional view showing that a wheelset RFID tag unit 1 according to Embodiment 1 is attached to a wheelset 10. FIG. 2A is a front view showing the wheelset RFID tag unit 1 of FIG. 1. FIG. 2B is a side view showing the wheelset RFID tag unit 1 of FIG. 1. As shown in FIGS. 1, 2A, and 2B, the RFID tag unit 1 is attached to the wheelset 10 of a railcar and is utilized for management of a product number of the wheelset 10. The RFID tag unit 1 of Embodiment 1 also serves as a resin plug which closes an axle end opening of the wheelset 10.

The wheelset 10 includes an axle 11 and a pair of wheels 12 provided at both sides of the axle 11. The wheelset 10 is made of metal. A bearings 13 is fitted to a portion of the axle 11 which portion is located outside the corresponding wheel 12 in a car width direction. The axle 11 is a hollow axle. A hollow space S of the axle 11 is open on an end surface 11a of the axle 11. An internal thread 11b is formed on a portion of an inner peripheral surface defining the hollow space S, the portion being located at an end of the axle 11. The RFID tag unit 1 is attached to the axle 11 so as to close the opening (axial end portion of the hollow space S) of the end surface 11a of the axle 11.

The RFID tag unit 1 includes a resin plug 2 (attaching member) and a RFID tag 3. The resin plug 2 closes the opening of the end surface 11a of the axle 11, and the RFID tag 3 is mounted on the resin plug 2. The resin plug 2 includes an insertion portion 2a and a flange portion 2b. The insertion portion 2a is inserted into the hollow space S through the end surface 11a of the axle 11, and the flange portion 2b is formed at one end of the insertion portion 2a. An external thread 2c which is threadedly engaged with the internal thread 11b is formed on an outer peripheral surface of the insertion portion 2a.

When the insertion portion 2a is inserted into the hollow space S, and the external thread 2c is threadedly engaged with the internal thread 11b, the flange portion 2b is brought into contact with the end surface 11a of the axle 11. The flange portion 2b includes a tool hole 2d into which a tool configured to rotate the resin plug 2 when attaching or detaching the resin plug 2 is inserted. The RFID tag 3 is fixed to an outer surface (car width direction outside surface) of the flange portion 2b.

The RFID tag 3 includes a base sheet 3a, an IC chip 3b mounted on the base sheet 3a, and an antenna 3c mounted on the base sheet 3a and connected to the IC chip 3b. The IC chip 3b stores identification information (ID) indicating the product number of the wheelset 10. Since the base sheet 3a of the RFID tag 3 is fixed to (for example, is adhered to) the resin plug 2 (i.e., the flange portion 2b of the resin plug 2), a portion to which the base sheet 3a is fixed is made of a non-metal material. The ID stored in the IC chip 3b of the RFID tag 3 is read through wireless communication using a reader (not shown).

As above, the resin plug 2 is interposed between the wheelset 10 made of metal and the RFID tag 3, and the resin plug 2 is made of a non-metal material. Therefore, not an expensive meal-compatible RFID tag but an inexpensive metal-incompatible RFID tag is used as the RFID tag 3. Moreover, since the resin plug 2 is utilized as the attaching member by which the RFID tag 3 is attached to the wheelset 10, the RFID tag 3 can be easily provided at the existing wheelset 10. Furthermore, since the RFID tag 3 is arranged on a rotation axis of the wheelset 10, centrifugal force is prevented from acting on the RFID tag 3 during rotation of the wheelset 10.

### Embodiment 2

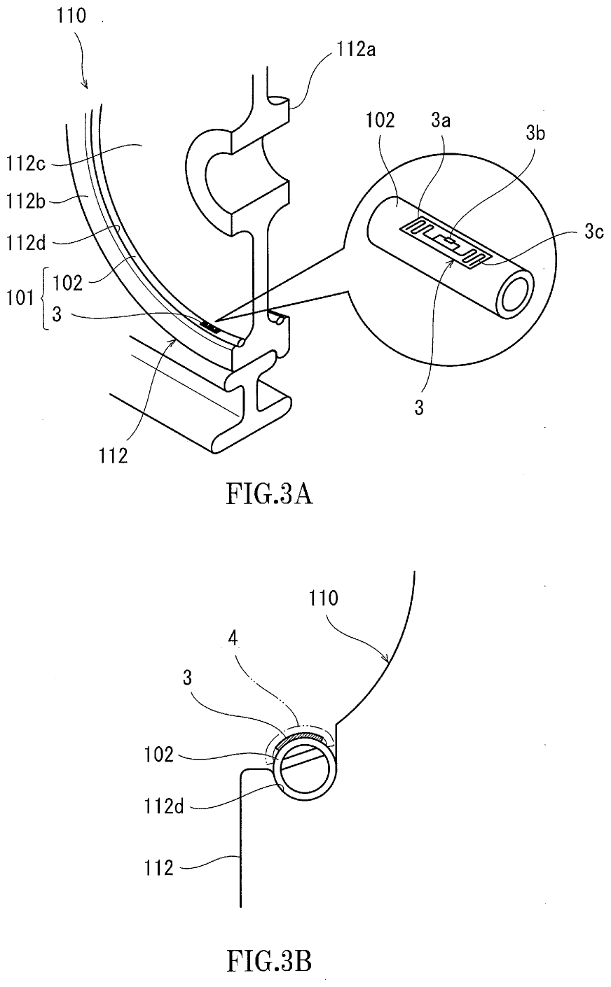

FIG. 3A is a perspective view showing that a wheelset RFID tag unit 101 according to Embodiment 2 is attached to the wheelset. FIG. 3B is a sectional view showing that the wheelset RFID tag unit 101 according to Embodiment 2 is attached to the wheelset. It should be noted that the same reference signs are used for the same components as in Embodiment 1, and explanations thereof are omitted. As shown in FIGS. 3A and 3B, the RFID tag unit 101 of Embodiment 2 also serves as a soundproof ring of a wheelset 110. A wheel 112 of the wheelset 110 includes a boss portion 112a, a rim portion 112b, and a circular plate portion 112c. The boss portion 112a is fitted to the axle. The rim portion 112b includes an outer peripheral surface on which a wheel tread is provided. The circular plate portion 112c connects the boss portion 112a to the rim portion 112b. An inner peripheral surface of the rim portion 112b at an outside of the circular plate portion 112c in the car width direction includes a groove 112d extending in a circumferential direction of the inner peripheral surface of the rim portion 112b.

The RFID tag unit 101 includes a soundproof ring 102 (attaching member) and the RFID tag 3. The soundproof ring 102 is fitted in the groove 112d of the rim portion 112b, and the RFID tag 3 is mounted on the soundproof ring 102. The soundproof ring 102 is made of an elastic material (rubber, for example). To be specific, the soundproof ring 102 is made of a non-metal material. The soundproof ring 102 does not have to have an endless closed loop shape. The soundproof ring 102 may be formed in such a manner that a linear body made of an elastic material is fitted in the groove 112d to resultantly form a ring shape.

In the present embodiment, an outer shape of the soundproof ring 102 in a sectional view is a circular shape. For example, the soundproof ring 102 is cylindrical. The RFID tag 3 is fixed to an inner peripheral surface of the soundproof ring 102. The base sheet 3a of the RFID tag 3 is soft. An attaching surface of the base sheet 3a attached to the soundproof ring 102 has a circular-arc shape along the soundproof ring 102 when viewed in the car width direction. In a sectional view of the soundproof ring 102, the attaching surface of the base sheet 3a has a circular-arc shape along the outer shape of the section of the soundproof ring 102.

As above, the soundproof ring 102 is interposed between the wheelset 110 made of metal and the RFID tag 3 faces the soundproof ring 102 made of a non-metal material. Therefore, the inexpensive metal-incompatible RFID tag 3 can be used instead of using the expensive meal-compatible RFID tag. Moreover, by utilizing the soundproof ring 102 attached to the wheel 112, the RFID tag 3 can be easily provided at the existing wheelset 110. Furthermore, since the RFID tag unit 101 is supported by the groove 112d from a radially outer side of the wheel 112, the RFID tag unit 1 can be prevented from falling off by the centrifugal force during the rotation of the wheelset 110. It should be noted that the RFID tag unit 101 may or may not include a protection cover 4 which covers an outer surface of the RFID tag 3 exposed to an outside and is made of non-metal. Similarly, in all the embodiments, the protection cover 4 may or may not be provided.

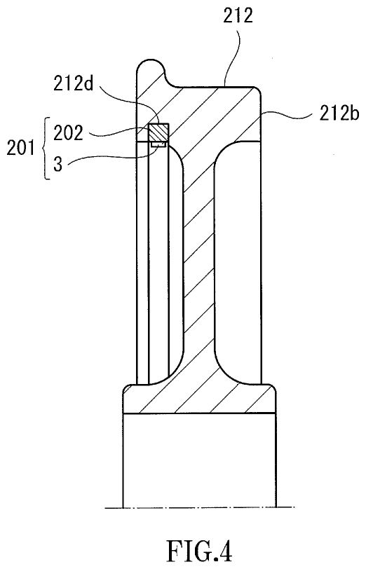

It should be noted that the same configuration as above can be adopted when as shown in FIG. 4, a soundproof ring 202 fitted in a groove 212d of a rim portion 212b of a wheel 212 has a rectangular section. To be specific, a wheelset RFID tag unit in which the RFID tag 3 is mounted on an inner peripheral surface of the soundproof ring 202 having a rectangular section may be used as a wheelset RFID tag unit 201.

### Embodiment 3

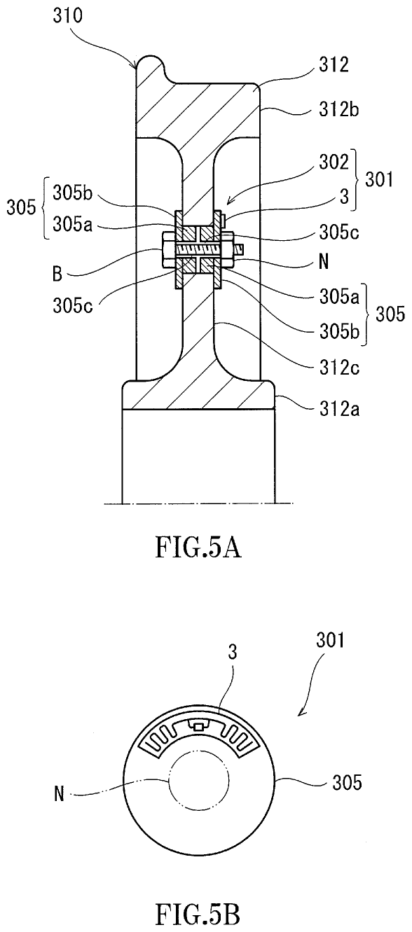

FIG. 5A is a sectional view showing that a wheelset RFID tag unit 301 according to Embodiment 3 is attached to the wheelset. FIG. 5B is a front view showing that the wheelset RFID tag unit 301 according to Embodiment 3 is attached to the wheelset. It should be noted that the same reference signs are used for the same components as in the above embodiments, and explanations thereof are omitted. As shown in FIGS. 5A and 5B, the RFID tag unit 301 of Embodiment 3 also serves as a resin plug which closes a lift hole of a wheel 312. In the wheel 312 of a wheelset 310 of the present embodiment, a circular plate portion 312c connecting a boss portion 312a and a rim portion 312b includes a lift hole 312d. The lift hole 312d is a hole used when the wheelset 310 is lifted by a crane or the like.

The RFID tag unit 301 includes a resin plug 302 and the RFID tag 3. The resin plug 302 closes the lift hole 312d of the wheel 312, and the RFID tag 3 is mounted on the resin plug 302. For example, the resin plug 302 includes a pair of plugs 305. Each of the plugs 305 includes an insertion portion 305a and a flange portion 305b. The insertion portion 305a is inserted into the lift hole 312d, and the flange portion 305b is provided at one end of the insertion portion 305a. A through hole 305c is formed at a middle of the plug 305.

The insertion portions 305a of the pair of plugs 305 are inserted into the lift hole 312d from both sides of the lift hole 312d, and the flange portions 305b are brought into contact with the circular plate portion 312c. In this state, a bolt B is inserted into the through holes 305c of the plugs 305 and is fastened with a nut N. The RFID tag 3 is fixed to an outer surface (car width direction outside surface) of the flange portion 305b of the plug 305 located at an outside in the car width direction out of the pair of plugs 305. More specifically, the RFID tag 3 is fixed to a position of the outer surface of the plug 305 which position does not correspond to the bolt B and the nut N.

As above, the resin plug 302 is interposed between the wheelset 310 made of metal and the RFID tag 3, and the RFID tag 3 faces the resin plug 302 made of a non-metal material. Therefore, the inexpensive metal-incompatible RFID tag 3 can be used instead of using an expensive meal-compatible RFID tag. Moreover, by utilizing the resin plug 302 which closes the lift hole 312d of the wheel 312, the RFID tag 3 can be easily provided at the existing wheelset 310.

### Embodiment 4

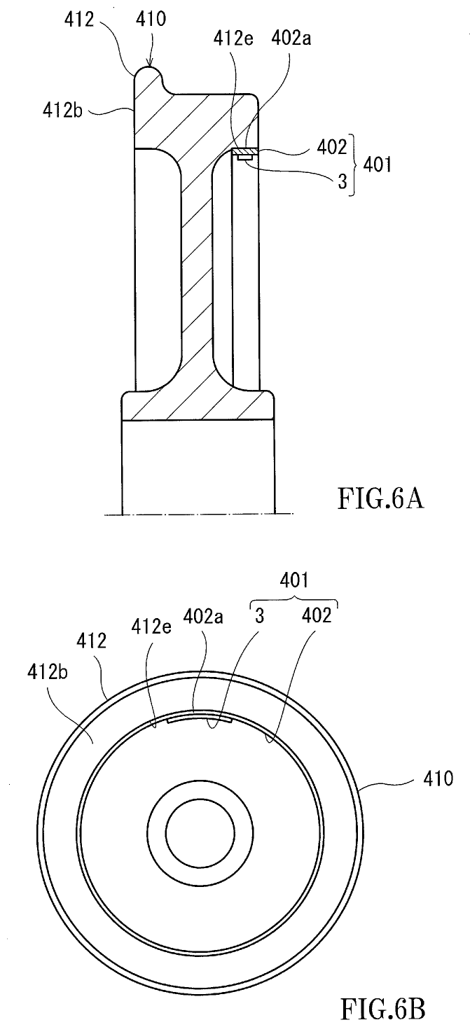

FIG. 6A is a sectional view showing that a wheelset RFID tag unit 401 according to Embodiment 4 is attached to the wheelset. FIG. 6B is a front view showing that the wheelset RFID tag unit 401 according to Embodiment 4 is attached to the wheelset. It should be noted that the same reference signs are used for the same components as in the above embodiments, and explanations thereof are omitted. As shown in FIGS. 6A and 6B, the RFID tag unit 401 includes a ring-shaped attaching member 402 and the RFID tag 3. The attaching member 402 is fitted to a peripheral surface of a wheelset 410 which surface extends around an axis of the wheelset 410, and the RFID tag 3 is mounted on the attaching member 402. An attaching surface of the RFID tag 3 (i.e., a surface opposed to the attaching member 402) has a circular-arc shape along the attaching member 402 when viewed in the car width direction. It should be noted that the attaching member 402 may have an endless-loop ring shape or may have an ended-loop (substantially C-shaped) ring shape.

Specifically, the attaching member 402 is fitted to an inner peripheral surface of a rim portion 412b of a wheel 412 of the wheelset 410. An attached surface 412e of the inner peripheral surface of the rim portion 412b is a surface to which the attaching member 402 is fitted and which is perpendicular to a radial direction of the wheel 412. The attaching member 402 is a tape-shaped ring made of resin, and an attaching surface 402a (outer peripheral surface) of the attaching member 402 has a cylindrical shape about an axis of the wheelset 410. The attaching surface 402a of the attaching member 402 is adhered to the attached surface 412e of the rim portion 412b. For example, when the attaching member 402 is made of plastic, the attaching member 402 may be adhered to the rim portion 412b with an adhesive. Moreover, when the attaching member 402 is made of rubber, the attaching member 402 may be adhered to the rim portion 412b by vulcanization.

An inner peripheral surface of the attaching member 402 supports the RFID tag 3 from a radially outer side of the wheel 412. Therefore, during the rotation of the wheelset 410, reaction force from the attached surface 412e with respect to the centrifugal force acting on the RFID tag 3 is not directed to an axial direction of the wheel 412 but directed to the radial direction of the wheel 412. Thus, the RFID tag unit 401 is suitably prevented from falling off. Since the RFID tag unit 401 is internally fitted to the rim portion 412b, the RFID tag unit 401 is prevented from falling off by the centrifugal force during the rotation of the wheelset 410. Moreover, since the attaching member 402 made of a non-metal material is interposed between the wheelset 410 made of metal and the RFID tag 3, the inexpensive metal-incompatible RFID tag 3 can be used instead of using an expensive meal-compatible RFID tag.

### Embodiment 5

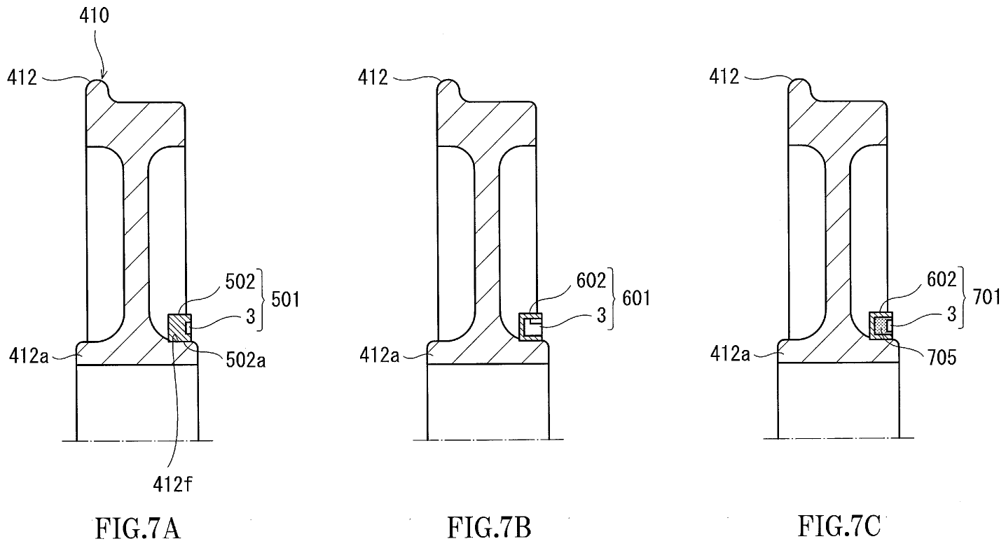

FIG. 7A is a sectional view showing that a wheelset RFID tag unit 501 according to Embodiment 5 is attached to the wheelset 410. It should be noted that the same reference signs are used for the same components as in the above embodiments, and explanations thereof are omitted. As shown in FIG. 7A, the RFID tag unit 501 includes a ring-shaped attaching member 502 and the RFID tag 3. The attaching member 502 is fitted to a peripheral surface of the wheelset 410 which surface extends around the axis of the wheelset 410, and the RFID tag 3 is mounted on the attaching member 502. It should be noted that the attaching member 502 may have an endless-loop ring shape or may have an ended-loop (substantially C-shaped) ring shape.

Specifically, the attaching member 502 is fitted to an outer peripheral surface of a boss portion 412a of the wheel 412 of the wheelset 410. An attached surface 412f of the outer peripheral surface of the boss portion 412a is a surface to which the attaching member 502 is fitted and which is perpendicular to the radial direction of the wheel 412. The attaching member 502 is a ring made of resin, and an attaching surface 502a (inner peripheral surface) of the attaching member 502 has a cylindrical shape about an axis of the wheelset 410. The attaching surface 502a of the attaching member 502 is adhered to the attached surface 412f of the boss portion 412a.

The RFID tag 3 is embedded in the attaching member 502. Therefore, the attaching member 502 includes a portion which supports the RFID tag 3 from a radially outer side. Moreover, since the attaching member 502 made of a non-metal material is interposed between the wheelset 410 made of metal and the RFID tag 3, the inexpensive metal-incompatible RFID tag 3 can be used. Since the RFID tag unit 501 is fitted to the outer peripheral surface of the boss portion 412a, the RFID tag unit 501 is prevented from falling off by the centrifugal force during the rotation of the wheelset 410. Moreover, since the RFID tag 3 is arranged at a portion of the attaching member 502 which portion is located outside in the car width direction, the RFID tag 3 can be easily read with a reader (not shown).

As shown in FIG. 7B, an attaching member 602 of a RFID tag unit 601 may be a resin ring having a U-shaped section that is open outward in the car width direction. In this case, the RFID tag 3 is provided on an inner peripheral surface of a radially outer side wall portion of the attaching member 602. With this, the RFID tag 3 is supported by the attaching member 502 from a radially outer side. Moreover, as shown in FIG. 7C, a RFID tag unit 701 may be configured such that: a resin filler 705 is filled in an internal space of the attaching member 602 having the U-shaped section; and the RFID tag 3 is embedded in the filler 705.

### Embodiment 6

FIG. 8 is a sectional view showing that a wheelset RFID tag unit 801 according to Embodiment 6 is attached to a wheelset 810. It should be noted that the same reference signs are used for the same components as in the above embodiments, and explanations thereof are omitted. As shown in FIG. 8, the RFID tag unit 801 includes a ring-shaped attaching member 802 and the RFID tag 3. The attaching member 802 is made of resin, and the RFID tag 3 is mounted on the attaching member 802. It should be noted that the attaching member 802 may have an endless-loop ring shape or may have an ended-loop (substantially C-shaped) ring shape. A boss portion 812a of a wheel 812 of the wheelset 810 includes a cutout portion 812g. The cutout portion 812g is formed in an annular shape around an axis of the wheel 812. To be specific, the cutout portion 812g includes a peripheral surface extending around the axis of the wheel 812.

The cutout portion 812g is formed by cutting a car width direction outside end portion of the boss portion 812a from an inner peripheral surface side of the boss portion 812a. To be specific, the cutout portion 812g is open outward in the car width direction and inward in the radial direction. It should be noted that the cutout portion 812g may be open outward in the car width direction without being open outward and inward in the radial direction. Since the RFID tag unit 801 is fitted to the cutout portion 812g, the RFID tag unit 801 is prevented from falling off from the wheel 812.

### Embodiment 7

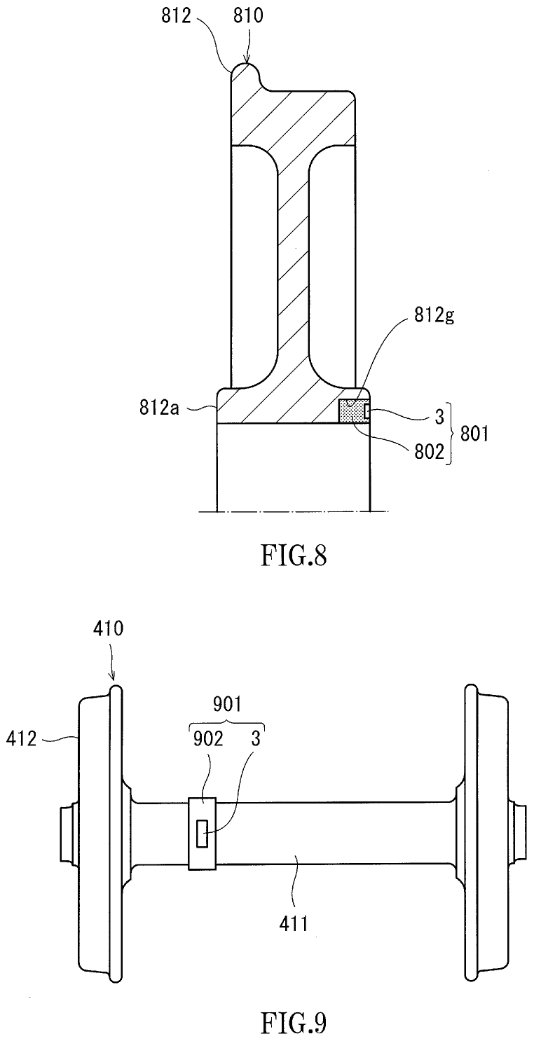

FIG. 9 is a plan view showing that a wheelset RFID tag unit 901 according to Embodiment 7 is attached to the wheelset 410. It should be noted that the same reference signs are used for the same components as in the above embodiments, and explanations thereof are omitted. As shown in FIG. 9, the RFID tag unit 901 includes a ring-shaped attaching member 902 and the RFID tag 3. The attaching member 902 is fitted to an outer peripheral surface of an axle 411 of the wheelset 410, and the RFID tag 3 is mounted on the attaching member 902. For example, the attaching member 902 is a belt-shaped member which is wound around the axle 411 and made of resin. An attaching surface of the RFID tag 3 (i.e., a surface opposed to the attaching member 902) has a circular-arc shape along the attaching member 902 when viewed in the car width direction.

The present disclosure is not limited to the above embodiments. Modifications, additions, and eliminations may be made with respect to the configurations of the embodiments. For example, the attaching surface of the RFID tag may have a circular-arc shape along a peripheral surface of the wheelset which surface extends around the axis of the wheelset, and the RFID tag may be directly fixed to (for example, adhered to) the peripheral surface of the wheelset. Moreover, the attaching member may be made of metal instead of resin. In this case, a meal-compatible RFID tag is only required to be used. Furthermore, the axle 11 shown in FIG. 1 is a hollow axle. However, each of the other axles may be a solid axle or a hollow axle.

1. A wheelset RFID tag unit configured to be attached to a wheelset of a railcar, the wheelset RFID tag unit comprising:
a RFID tag; and
mounter on which the RFID tag is mounted and which is configured to be attached to the wheelset, wherein:
at least a portion of the mounter which portion faces the RFID tag is made of a non-metal material; and
the mounter is interposed between the RFID tag and the wheelset.

2. The wheelset RFID tag unit according to claim 1, wherein:
an axle of the wheelset is a hollow axle including a hollow space that is open on an end surface of the axle; and
the mounter is a resin plug which closes an opening of the end surface of the axle.

3. The wheelset RFID tag unit according to claim 1, wherein:
a groove is formed on an inner peripheral surface of a rim portion of a wheel of the wheelset; and
the mounter is a soundproof ring which is fitted in the groove of the wheelset and is made of an elastic material.

4. The wheelset RFID tag unit according to claim 1, wherein:
a lift hole is formed on a circular plate portion of a wheel of the wheelset; and
the mounter is a resin plug which closes the lift hole of the wheel.

5. The railcar wheelset RFID tag unit according to claim 1, wherein the mounter is a substantially ring-shaped member fitted to a peripheral surface of the wheelset, the peripheral surface extending around an axis of the wheelset.

6. A railcar wheelset RFID tag unit configured to be attached to a wheelset of a railcar, the railcar wheelset RFID tag unit comprising:
a RFID tag; and
an mounter on which the RFID tag is mounted and which is configured to be attached to the wheelset, wherein
the mounter includes a portion which supports the RFID tag from a radially outer side of the wheelset against centrifugal force.

7. The railcar wheelset RFID tag unit according to claim 6, wherein the mounter is a substantially ring-shaped member fitted to a peripheral surface of the wheelset, the peripheral surface extending around an axis of the wheelset.

8. The railcar wheelset RFID tag unit according to claim 7, wherein:
an attaching surface of the mounter has a cylindrical shape about the axis of the wheelset; and
the attaching surface of the mounter is configured to be attached to an attached surface of the peripheral surface of the wheelset, the attached surface being perpendicular to a radial direction of the wheelset.

9. A wheelset RFID tag unit configured to be attached to a wheelset of a railcar, the wheelset RFID tag unit comprising:
a RFID tag; and
a circular-arc attaching surface configured to be attached to a peripheral surface of the wheelset, the peripheral surface extending around an axis of the wheelset.
